(19) United States
(12) Patent Application Publication
(10) Pub. No.: US 2007/0105984 A1
(43) Pub. Date: May 10, 2007

(54) Composition comprising cellulose and polyvinyl chloride polymer

(76) Inventor: Elizabeth R. Griffin, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/593,276

(22) Filed: Nov. 6, 2006

Related U.S. Application Data
(60) Provisional application No. 60/734,065, filed on Nov. 7, 2005.

(51) Int. Cl. C09D 101/18; C09B 67/00

(52) U.S. Cl. 524/31; 524/502; 524/567

(57) ABSTRACT

Disclosed are compositions comprising cellulosic material, PVC or a PVC copolymer, and a coupling agent which comprises a grafted polymer, an ethylene copolymer, a carboxylated polyacrylate or mixtures thereof. Articles made from the composite cellulosic compositions are also disclosed.

### CROSS-REFERENCE TO RELATED APPLICATION

This application claims the benefit of U.S. Provisional Application No. 60/734,065, filed Nov. 7, 2005.

### FIELD OF THE INVENTION

This invention relates to a composition comprising cellulosic material, polyvinyl chloride or copolymer thereof, and a coupling agent, to a masterbatch composition comprising the cellulosic material and coupling agent, and to a process for reducing water absorption of a cellulosic material.

### BACKGROUND OF THE INVENTION

With the rising cost of wood and the shortage of mature trees, there is a present need to find good quality substitutes for wood, a need which will continue long into the future. Over the past several years a growing market has emerged for the use of polymer-wood composites to replace traditional solid wood products in applications such as decking, windows, fencing, automobile interiors and pallets. These composite materials typically consist of mixtures of thermoplastic materials with wood particles in the form of sawdust. The composite materials may be used in many of the same applications as all-wood products but offer the advantages of providing flame resistance, as well as enhanced resistance to rot, attack by insects, and deterioration due to the effects of moisture and sunlight. These products can have the same workability as wood, are splinter-free, and are capable of being colored in bulk as opposed to wood, which can only be surface stained or painted.

Recently there has been an increased interest in composites of wood and polyvinyl chloride (PVC), particularly for use as replacements for natural wood, for example, as interior or exterior decorative moldings for buildings and as railroad ties, picture frames, furniture, porch decks, railings, window moldings, window components, door moldings, door components, roofing systems, home siding, or other types of structural members. Such composites are highly desirable because they resemble traditional wood siding and raise the sag temperature of PVC, permitting the use of dark colors in the composite siding. For example, PVC wood composite compositions are disclosed U.S. Patent Publication 2006/0173105. Dark colored PVC absorbs a considerable amount of heat in sunlight and exhibits a tendency to sag. See, e.g., U.S. Pat. Nos. 6,011,091; 6,103,791; and 6,066,680; and US Patent Application 2003/0229160.

Known composites that contain more than about 40 weight % wood may suffer from edge tear and slow, difficult extrusion.

It is highly desirable to develop PVC/wood compositions that comprise wood yet still have physical properties that allow them to be manufactured using typical PVC processes and to be used in traditional PVC applications such as home siding.

### SUMMARY OF THE INVENTION

In particular, the invention is directed to a composition comprising
(a) from about 10 wt. % to about 95 wt. % of cellulosic material, based on the total weight of the composition,
(b) from about 5 wt. % to about 95 wt. % of polyvinyl chloride or polyvinyl chloride copolymer, based on the total weight of the composition and
(c) from about 1 wt. % to about 20 wt. % of a coupling agent, based on the total weight of the composition, wherein the coupling agent is selected from the group consisting of grafted polymers, ethylene copolymers, carboxylated polyacrylates and mixtures thereof.

The invention is further directed to an article comprising the above-described composition of the invention.

The invention also includes a masterbatch composition comprising about 50 wt. % to about 95 wt. % of cellulosic material, based on the total weight of the masterbatch composition and from about 5 wt. % to about 50 wt. % of a coupling agent, based on the total weight of the composition, wherein said masterbatch optionally includes PVC or PVC copolymer.

The invention also includes a process for reducing water absorption of a composite comprising cellulosic material and PVC or PVC copolymer.

### DETAILED DESCRIPTION OF THE INVENTION

A wide variety of cellulosic materials can be employed as components of the compositions of the invention. Such materials include those obtained from wood and wood products, such as wood pulp fibers; non-woody paper-making fibers from cotton; straws and grasses, such as rice and esparto; canes and reeds, such as bagasse; bamboos; stalks with bast fibers, such as jute, flax, kenaf, cannabis, linen and ramie; and leaf fibers, such as abaca and sisal; paper or polymer-coated paper including recycled paper and polymer-coated paper. Preferably the cellulosic material used is from a wood source. Suitable wood sources include softwoods such as pine, spruce, and fir and hardwoods such as oak, maple, eucalyptus, poplar, beech, and aspen. The cellulosic material from wood sources can in the form of sawdust, wood chips, wood flour or the like.

In addition to sawdust, agricultural residues and/or waste can be used. Agricultural residues are the remainder of a crop after the crop has been harvested. Examples of such suitable residues include residues from the harvesting of wheat, rice, and corn, for example. Examples of agricultural waste suitable for use herein include straw; corn stalks; rice hulls; wheat; oat; barley and oat chaff; coconut shells; peanut shells; walnut shells; jute; hemp; bagasse; bamboo; flax; and kenaff; and combinations thereof.

One or more cellulosic materials, such as those described above can be used as components of the composition of the invention.

The cellulosic materials may be screened through various screens, e.g., a 30-mesh or a 40-mesh screen, to obtain a mixture of different size particulate material. The size of the cellulose particles used in the composition of the present invention can range from about 10 to about 100 mesh or about 40 to about 100 mesh.

Suitable wood flours include soft and hard woods and combinations thereof. Preferable wood flours are oak and pine, available as OAK 4037 (40 mesh) and PINE 402050 (40 mesh), respectively from American Wood Fibers of Schofield, Wis. Maple wood flour can also be used.

The second component of the compositions of the invention is a vinyl chloride polymer. Polyvinylchloride homopolymers, i.e. those compositions containing only vinyl chloride copolymerized units (PVC) and PVC copolymers may be used. PVC copolymers useful as components of the composition of the invention comprise copolymerized units of vinyl chloride and one or more copolymerizable comonomers. Examples include copolymers such as PVC vinyl acetate copolymers, PVC n-butyl acrylate copolymers or combinations thereof.

One or more other thermoplastic polymers can additionally be present in the compositions of the invention including, for example, polyolefins such as high density polyethylene, low density polyethylene, linear low density polyethylene, ultrahigh molecular weight polyethylene, ultra low density polyethylene, copolymers of ethylene and a second α-olefin monomer prepared in the presence of a metallocene catalyst (metallocene polyethylenes, or MPE), ethylene/propylene copolymers, terpolymers such as ethylene/propylene/diene terpolymers, generically known as EPDMs, polypropylene homopolymers or copolymers, PVC vinyl acetate copolymers, chlorinated PVC, polystyrene, or mixtures thereof. As used herein the term metallocene catalyst also includes constrained geometry and single site catalysts.

Coupling agents useful as components of the compositions of the invention include polymers selected from the group consisting of grafted polymers, ethylene copolymers, carboxylated polyacrylates and mixtures thereof.

Grafted polymers include modified polymers that have been functionalized by grafting functional group containing monomers onto a base resin, generally an alpha-olefin homopolymer or an alpha-olefin copolymer. Such grafted polymers are often used to promote bonding between polymers used in toughened, filled, and blended compounds. The polymers to be functionalized with the grafting agent, i.e. the grafting monomer, include polyethylene, polypropylene, ethylene copolymers, PVC or PVC copolymers, ethylene vinyl acetates, metallocene-produced polyethylenes, ethylene propylene copolymer rubbers, including EPDM rubber, polybutyl(meth)acrylate, or mixtures thereof.

Suitable grafted polymers can comprise from about 0.01 wt. % to about 10 wt. %, based on the weight of the polymer, of grafted monomer units, including grafted units of unsaturated dicarboxylic acids, anhydrides of unsaturated dicarboxylic acids, salts of unsaturated dicarboxylic acids, mono- or di-esters of unsaturated dicarboxylic acids and mixtures thereof.

Examples of such grafting monomers include maleic acid, itaconic acid, fumaric acid, itaconic anhydride, fumaric anhydride, maleic anhydride, citraconic anhydride, itaconic anhydride, tetrahydrophthalic anhydride, maleic acid mono- or di-ester, and fumaric acid monoester and mixtures thereof. Grafted polymers that are coupling agent components of the invention do not include reaction products of the above-described grafted polymers with an additional polymer, such as compositions disclosed in U.S. Patent Publication 2006/173105.

The grafted polymer can be obtained by known techniques, for example by a process in which a resin is substantially dispersed or dissolved in an organic solvent along with an unsaturated dicarboxylic acid anhydride and a radical generator, followed by heating with stirring. Alternatively, a process in which all the components are fed to an extruder may be used. Such a process is used commercially for preparing grafted polymers such as a maleic-anhydride grafted polypropylene. Examples of grafted polymers include maleated ethylene butyl acrylate carbon monoxide copolymers, maleated ethylene vinyl acetate carbon monoxide copolymers, maleated ethylene methyl acrylate copolymers, maleated ethylene butyl acrylate copolymers, maleated ethylene ethyl acrylate copolymers, maleated ethylene vinyl acetate copolymers, maleated vinyl chloride vinyl acetate copolymers, maleated vinyl chloride butyl acrylate copolymers, maleated polyethylene, maleated polypropylene, maleated styrene-ethylene-butene-styrene block copolymer, maleated polybutadiene, maleated methacrylate butadiene styrene copolymer, maleated polybutylacrylate and mixtures thereof. The term “maleated” refers to polymers grafted with maleic anhydride or acid. Such graft copolymers are available commercially from E. I. du Pont de Nemours and Company, Wilmington, Del. (DuPont) under the FUSABOND® trademark and include materials such as FUSABOND® A MG423D (ethylene/alkyl acrylate/CO copolymer that has been modified with maleic anhydride.

Suitable ethylene copolymers that may be used as coupling agents can comprise copolymerized units of ethylene and polar comonomers. These copolymers are prepared by copolymerization reactions, generally free radical random copolymerization reactions, rather than by grafting reactions. Suitable comonomers that may be employed include acrylic acid, methacrylic acid, ethacrylic acid, methyl acrylate, ethyl acrylate, methyl methacrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, 2-hydroxyethyl methacrylate, vinyl acetic acid, vinyl acetate, vinyl propionate, and mixtures thereof. Examples of ethylene copolymers include, but are not limited to, ethylene/acrylic acid, ethylene/vinyl acetate, ethylene/methyl acrylate, ethylene/ethyl acrylate, ethylene/butyl acrylate, ethylene/isobutyl acrylate, ethylene/isobutyl acrylate/methacrylic acid, ethylene/methyl acrylate/maleic anhydride, ethylene/butyl acrylate/glycidyl methacrylate, ethylene/vinyl acetate/carbon monoxide, ethylene/butyl acrylate/carbon monoxide and mixtures thereof. Such ethylene copolymers can be produced by means known to one skilled in the art, for example using either autoclave or tubular reactors and processes such as described in U.S. Pat. Nos. 3,404,134; 5,028,674;

6,500,888 and 6,518,365).

Examples of other suitable comonomers include maleic acid, itaconic acid, fumaric acid, itaconic anhydride, fumaric anhydride, maleic anhydride, citraconic anhydride, itaconic anhydride, tetrahydrophthalic anhydride, maleic acid mono- or di-esters, fumaric acid monoesters and mixtures thereof.

Ethylene copolymers may be those that include such comonomers as ethylene monomethyl maleate copolymers, ethylene dimethyl maleate copolymers, ethylene monoethyl maleate copolymers, ethylene diethyl maleate copolymers, ethylene monopropyl maleate copolymers, ethylene monobutyl maleate copolymers and mixtures thereof.

Such ethylene copolymers also include ethylene/alkyl acrylate copolymers containing a monoalkyl ester of a 1,4-butenedioic acid as a curesite monomer. A monoalkyl ester of 1,4-butenedioic acid includes any unsaturated dicarboxylic acid or derivative thereof that, after polymerization, results in formation of a succinic acid moiety along the backbone of the terpolymer which can subsequently be monoesterified. This includes, for example, the monoalkyl esters of maleic acid and fumaric acid such as monomethyl maleic acid and monoethyl maleic acid. Examples of ethylene copolymers include ethylene/maleate copolymers such as ethylene/maleic anhydride or ethylene/ethyl hydrogen maleate (ethylene/maleic acid monoester) (E/MAME).

An ethylene copolymer suitable as a coupling agent can also include an elastomeric composition that is an ethylene/alkyl acrylate copolymer having the copolymerized curesite monomer 4-(dialkylamino)-4-oxo-2-butenoic acid or the copolymerized curesite monomer MAME. For example, a random ethylene copolymer can be prepared by copolymerization of ethylene with from about 10 to about 40 weight %, preferably 20 to 30 wt. % of a first alkyl acrylate; from about 15 to about 65 weight %, preferably 35 to 45 wt. % of a second alkyl acrylate; and up to about 5 weight % of the curesite monomer. Other similar copolymers have a curesite monomer that is an anhydride of the acid or a monoalkyl ester of the acid wherein the alkyl group in the monoalkyl ester has up to 6 carbon atoms and the acid is as disclosed above. The elastomer can optionally be vulcanized. Examples of elastomeric ethylene copolymers of this type include Vamac® ethylene acrylic elastomers, available from DuPont.

The copolymerized comonomer units can be present in the ethylene copolymer in amounts of about 5 wt. % to about 75%, preferably about 10 wt. % to about 50 wt. %, more preferably 15 wt. % to 35 wt. %, based on the weight of the ethylene copolymer

The ethylene copolymers may terpolymers or higher order copolymers and may comprise up to 35 wt % of a comonomer such as vinyl acetic acid, vinyl acetate, vinyl propionate, carbon monoxide, sulfur dioxide, acrylonitrile, glycidyl acrylate, glycidyl methacrylate, and glycidyl vinyl ether and mixtures thereof.

If the ethylene copolymer is an ethylene carboxylic acid copolymer, the acid moiety of an ethylene carboxylic acid copolymer may be neutralized with a cation to produce an ionomer. The degree of neutralization can range from about 0.1 to about 100%. In certain embodiments the degree of neutralization may range from about 10 to about 90%, in other cases from about 20 to 80%, and in still others about 20 to about 40%, based on the total carboxylic acid content. The neutralizing cation may be a metallic ion. The metallic ions can be monovalent, divalent, trivalent, multivalent, or mixtures thereof. Suitable ions include ions of elements of Group Ia, Group IIa, Group Ib, Group IIb, Group IIIb, Group IVa and Group VIII. Examples of suitable ions include lithium, sodium, potassium, magnesium, calcium, tin, nickel, titanium and aluminum. Mixtures of ions may also be used. If the metallic ion is multivalent, a complexing agent, such as stearate, oleate, salicylate, and phenolate radicals can be included, as disclosed in U.S. Pat. No. 3,404,134.

Examples of commercially available ethylene copolymers having polar functional groups include those available from DuPont having the trademarks Surlyn®, Nucrel®, Appeel®, Bynel®, Elvaloy® and Elvax®.

A further suitable coupling agent is a carboxylated polyacrylate copolymer, for example a polyacrylate copolymerized with a monoalkyl ester of a 1,4-butene-dioic acid cure-site termonomer.

The coupling agent can be present in the cellulosic composite compositions of the invention in an amount of from about 0.1 to about 20 wt. %, based on the weight of the composition. In other embodiments 0.2 to about 10 wt. % is preferred, and in still other embodiments about 0.3 to about 6 weight % will be preferred, based on the weight of the composition. A particular feature of the invention is that the coupling agent acts to reduce the water absorption of the composite comprising cellulosic material and PVC and achieves improvements in the physical, mechanical and thermal characteristics of the composite. This is important because reduction of water absorption aids in maintaining shape and integrity of articles formed from the compositions of the invention. Water absorption of compositions of the invention is reduced up to 50% compared to compositions that contain two-component mixtures of a cellulosic component of the invention and a polyvinyl chloride or polyvinylchloride copolymer of the invention, when tested according to ASTM D570. Reductions of 20-30% are typical and the precise amount will depend on the particular cellulosic component and PVC or PVC copolymer component. A coupling agent may also reduce the viscosity of the composite, thereby improving the processibility of the composite when it is formed into shaped articles such as by extrusion or compression molding. The presence of the coupling agent may also allow formation of processible composites that contain about 40 or 50 weight % or greater of cellulosic material, based on the total weight of the composite. Such levels are particularly useful in PVC/wood composites, where it can be difficult to achieve high wood concentration and yet retain good processing and formability properties. The composite compositions of the present invention can include from about 10 to about 90 wt. % cellulosic material, based on the weight of the compositions. In some embodiments 30 to about 60 wt. % will be preferable. In others 40 % to 55 wt. % will be preferred. The polyvinyl chloride or vinyl chloride copolymers will be present in amounts of from 5 wt. % to about 95 wt. %, based on the total weight of the composition. In certain embodiments 10 wt. % to about 70 wt. % will be preferred; in other embodiments 40 wt. % to 60 wt. % is preferred. In still other embodiments 35 to 50 wt. % will be preferred. An optional thermoplastic polymer, other than the coupling agent, PVC and PVC copolymer components, may also be present.

The compositions of the invention can be produced by methods known to one skilled in the art such as combining a cellulose material (e.g., wood, sawdust or wood flour) PVC polymer or copolymer, optionally with a thermoplastic polymer, and a coupling agent in a mixer, e.g. a ribbon blender or any low intensity mixer commonly used in blending solids. The mixture can then be processed in conventional equipment, such as a two-roll mill, a Banbury mixer or a heated extruder at temperatures suitable for processing the particular polymer components of the composition.

In a masterbatch method, a masterbatch can be produced from about 50 to about 95% or about 75 to about 90 weight % of cellulosic material (e.g., sawdust or wood flour) and from about 5 to about 10%, or about 10 to about 25% of a coupling agent, where the weight percentages are based on the total weight of the masterbatch composition. The resulting masterbatch can be blended with a PVC or PVC copolymer and optionally a thermoplastic polymer to obtain composites having the same ratio of components as those prepared by direct blending of the ingredients. The masterbatch method provides a material that is a blend of cellulosic material and coupling agent that can be prepared, stored and subsequently used to react with any chosen thermoplastic polymer. The masterbatch method can also increase the wetting of the cellulosic material with the coupling agent, thereby providing composites with somewhat enhanced properties.

The compositions can additionally comprise conventional additives used in polymeric materials including plasticizers, impact modifiers, stabilizers including viscosity stabilizers and hydrolytic stabilizers, antioxidants, ultraviolet ray absorbers, antistatic agents, dyes, pigments or other coloring agents, inorganic fillers, fire-retardants, lubricants, reinforcing agents such as glass fiber and flakes, foaming or blowing agents, processing aids, antiblock agents, release agents, and mixtures thereof. Optional additives, when used, can be present in various quantities so long as they are not used in an amount that detracts from the basic and novel characteristics of the composition.

An inorganic filler can optionally be used that comprises particles of inorganic compounds, such as minerals and salts. The amount of filler that can be added to the composition of the present invention is not critical, but will generally be from 0.001 to about 50 wt %, based on the total weight of the composition.

Foaming or blowing agents known to one skilled in the art can be incorporated in amounts of from about 0.001 to 3 wt. %, based on the total weight of the composition. These agents reduce the density of the artificial lumber product, and also to “size” the product to the required dimensions in an extrusion process. Examples of solid blowing agents of the masterbatch mix are combinations of monosodium citrate and sodium bicarbonate, preferably encapsulated in vegetable oil (i.e. a mixture of mono-, di-, and/or tri-glycerides), the amounts of monosodium citrate and sodium bicarbonate are present preferably also as a stoichiometric mixture. Examples of commercial solid blowing agents are the SAFOAM® P and SAFOAM® FP powders (mixture of monosodium citrate and sodium bicarbonate encapsulated in vegetable oil), available from Reedy International Corporation, Keyport, N.J., as disclosed in U.S. Pat. No. 5,817,261. Exothermic blowing agents include azodicarbonamide, 4,4-oxy-bis(benzenesulfonyl hydrazole), p-toluenesulfonyl semicarbazide, phenyl tetrazole or mixtures thereof. Endothermic blowing agents include inorganic carbonates and bicarbonates including magnesium carbonate, bicarbonate, or combinations thereof.

Heat stabilizers can optionally be used in amounts of from about 0.001 to about 10 wt. %, based on the total weight of the composition, to prevent degradation of the composite due to heat histories. Suitable heat stabilizers include, for example, a calcium/phosphate derivative of a hindered phenol sold under the trademark RECYCLOSTAB® 411 (calcium phosphate) and available from Ciba Specialty Chemicals (Tarrytown, N.Y.). The heat stabilizer compound can also be one or more hydroxylamines, phenols, phosphates, and metal soaps. Conventional polyvinyl chloride stabilizers, well known in the art, may also be used.

Suitable optional antioxidants include alkylated phenols and bis-phenols such as hindered phenols, polyphenols, thio and di-thio polyalkylated phenols, lactones such as 3-arylbenzofuran-2-one and hydroxylamine, as well as Vitamin E.

Reinforcing agents such as glass fiber and flakes can optionally be used to improve flex modulus of the wood composite, allowing it to have greater stiffness and strength suitable for structural applications.

The compositions can be formed into shaped articles using methods such as injection molding, compression molding, overmolding or extrusion. Optionally, formed articles comprising the composite of the present invention can be further processed. For example, pellets, slugs, rods, ropes, sheets and molded articles of the present invention may be prepared and used for feedstock for subsequent operations, such as thermoforming operations, in which the article is subjected to heat, pressure and/or other mechanical forces to produce shaped articles. Compression molding is an example of further processing.

The compositions can be cut, injection molded, compression molded, overmolded, laminated, extruded, milled or the like to provide the desired shape and size to produce commercially usable products. The resultant product may have an appearance similar to wood and may be sawed, sanded, shaped, turned, fastened and/or finished in the same manner as natural wood. These materials are resistant to rot and decay as well as termite attack and may be used as a replacement for natural wood, for example, as decorative interior or exterior moldings on houses, railroad ties, picture frames, furniture, porch decks, railings, window moldings, window components, door components, roofing systems, sidings, or other types of structural members.

The following examples illustrate certain embodiments of the invention.

### EXAMPLES

Materials

Wood Flour: HUBER F06 Wood Flour

Polyvinyl Chloride: PVC (K value 55)

Coupling agent: FUSABOND® A MG423D adhesive resin

Compatibilizing Agent Control: Reaction product of polyvinyl butyral and FUSABOND® A MG423D adhesive resin,

Heat Stabilizer: Witco MARK 1178, Witco Mark 3705

Acid Scavenger: DRAPEX 6.8 Epoxidized Soy Oil

### Example 1

A composition of the invention was prepared containing 50.0 wt. % wood flour, 28.74 wt. % polyvinyl chloride, 16.67 wt. % FUSABOND® A MG423D, 1.15 wt. % Witco Mark 3705, 0.57 wt. % Witco Mark1178 and 2.87 wt. % Drapex 6.8 Expoxidized soy oil. All percentages are based on the total weight of the composition.

The Witco Mark 3705, Witco Mark 1178 and Drapex 6.8 were added to the polyvinyl chloride in a Welex dry blend mixer using dry blending procedures to form a polyvinyl chloride dry blend. The polyvinyl chloride dry blend (33.33 wt. %), the wood flour (50 wt. %) and the FUSABOND® A MG423D (16.67 wt. %) were combined using a BRABENDER Prep mixer (300 cc bowl) with roller blades at 180° C. and 60 rpm. Mixing was conducted for a maximum of 7 minutes to form a composite material.

Plaques of the composite material produced were compression molded into 6 in×6 in×40 mil and 6 in×6 in×125 mil samples at 350° F. for 4 minutes at 28,000 psi, and then test specimens were cut using a jigsaw. Tensile test type 4 bars were cut from 40 mil thick plaques and flex bars 5 in. by 0.5 in. were cut from 125 mil thick plaques. The specimens were tested in accordance with ASTM D638, ASTM D790, ASTM E831 (measuring linear thermal expansion between 40 to 23° C.) and ASTM D570 using flex bars for the water absorption test. The results are shown in Table 1.

Control 1A was prepared In a similar manner and contained 50.0 wt. % wood flour, 28.74 wt. % polyvinyl chloride, 16.67 wt. % of the Compatibilizing Agent Control, 1.15 wt. % Witco Mark 3705, 0.57 wt. % Witco Mark 1178 and 2.87 wt. % Drapex 6.8. All percentages are based on the total weight of the composition. Test specimens were prepared as described above for the Example 1 composition.

Control 1B contained 50. wt. % wood flour, 43.10 wt. % PVC, 1.72 wt. % Witco Mark 3705, 0.86 wt. % Witco Mark 1178 and 4.31 wt. % Drapex 6.8.and was prepared in a similar manner.

TABLE 1

| | Example 1 | Control 1A | Control 1B |
|---|---|---|---|
| Tensile Strength (kpsi) | 1.75 | 1.66 | 2.1 |
| Break Elongation (%) | 3.7 | 0.4 | 0.3 |
| Flex Modulus (kpsi) | 103 | 367 | 516 |
| Coefficient of Thermal Linear | 44.9 | 48.2 | 34.6 |
| Expansion (μm/mC. °) | | | |
| Water Absorption, % weight | 9.2% | 13.1% | 13.2% |
| increase, 96 hours | | | |

### Example 2

Two masterbatches of wood flour and a coupling or compatibilizing agent were prepared as follows. Coupling or compatibilizing agent was banded on a roll mill at 250° C. Then wood flour was added. The first masterbatch was a masterbatch of the invention containing 25 wt. % FUSABOND® A MG423D and 75 wt. % wood flour. A control masterbatch, 2A, having the composition 75 wt. % wood flour and 25 wt. % Compatibilizing Agent Control was prepared in the same manner. A second control masterbatch that contained 100% wood flour was also prepared. Compositions to be tested were prepared by mixing the masterbatches with a PVC dry blend. The PVC dry blend had the following composition: 86.21 wt. % PVC, 3.45 wt. % Witco Mark 3705, 1.72 wt. % Witco Mark 1178 and 8.62 wt. % Drapex 6.8 epoxidized soy oil and was prepared in a Wellex dry blend mixer. The PVC and the wood flour masterbatches were combined using a BRABENDER Prep mixer (300 cc bowl) with roller blades, at 180° C. and 60 rpm. The PVC dry blend was added to the mixer and then the masterbatch was added. Mixing was conducted for a maximum of 7 minutes. The test composition of the invention contained 50 wt. % wood, 33.3 wt. % PVC dry blend and 16.7 wt. % FUSABOND® A MG423D. The Control 2A test composition contained 50 wt. % wood, 33.3 wt. % PVC dry blend and 16.7 wt. % Compatibilizing Agent Control. The Control 2B composition contained 50 wt. % wood and 50 wt. % PVC dry blend. Weight percentages are based on the weight of wood flour, PVC and coupling or compatibilizing agent, if present.

Plaques (6 in×6 in×40 or 125 mil) were prepared by compression molding at 350° F. for 4 minutes under 28,000 psi. Test specimens were prepared and testing was carried out as described in Example 1. The results are shown in Table 2.

TABLE 2

| | Example 2 | Control 2A | Control 2B |
|---|---|---|---|
| Tensile Strength (kpsi) | 2.26 | 2.26 | 2.1 |
| Flex Modulus (kpsi) | 100 | 321 | 367 |
| Coefficient of Thermal Linear | 59.28 | 33.4 | 34.6 |
| Expansion (μm/mC. °) | | | |
| Water Absorption, % weight | 6.2 | 10.0 | 13.2 |
| increase, 96 hours | | | |

1. A composition comprising
(a) from about 10 wt. % to about 95 wt. % of cellulosic material, based on the total weight of the composition,
(b) from about 5 wt. % to about 95 wt. % of polyvinyl chloride or polyvinyl chloride copolymer, based on the total weight of the composition and
(c) from about 1 wt. % to about 20 wt. % of a coupling agent, based on the total weight of the composition, wherein the coupling agent is selected from the group consisting of grafted polymers, ethylene copolymers, carboxylated polyacrylates and mixtures thereof.

2. A composition of claim 1 additionally comprising a thermoplastic polymer that is other than polyvinyl chloride, a polyvinyl chloride copolymer or said coupling agent of claim 1.

3. A composition of claim 1 additionally comprising a polymer selected from the group consisting of high density polyethylene, low density polyethylene, linear low density polyethylene, ultrahigh molecular weight polyethylene, ultra low density polyethylene, copolymers of ethylene and a second a-olefin monomer prepared in the presence of a metallocene catalyst, ethylene/propylene copolymers, ethylene propylene terpolymers, polypropylene homopolymers, propylene copolymers, polystyrene, and mixtures thereof, wherein said additional polymer is other than polyvinyl chloride, a polyvinyl chloride copolymer or said coupling agent of claim 1.

4. A composition of claim 1 wherein the coupling agent is a grafted polymer said polymer being selected from the group consisting of polyethylene, polypropylene, ethylene copolymers, polyvinyl chloride, polyvinyl chloride copolymers, ethylene vinyl acetate copolymers, metallocene-produced polyethylenes, ethylene propylene copolymer rubbers, polybutylacrylate, polybutylmethacrylate and mixtures thereof that has been grafted with a grafting agent selected from the group consisting of unsaturated dicarboxylic acids, anhydrides of unsaturated dicarboxylic acids, salts of unsaturated dicarboxylic acids, mono- or di-esters of unsaturated dicarboxylic acids and mixtures thereof.

5. A composition of claim 4 wherein the grafted polymer is a grafted ethylene copolymer and said grafted ethylene copolymer is selected from the group consisting of maleated ethylene butyl acrylate carbon monoxide copolymers, maleated ethylene vinyl acetate carbon monoxide copolymers, maleated ethylene methyl acrylate copolymers, maleated ethylene butyl acrylate copolymers, maleated ethylene ethyl acrylate copolymers, maleated ethylene vinyl acetate copolymers and maleated vinyl chloride vinyl acetate copolymers.

6. A composition of claim 1 wherein the coupling agent is an ethylene copolymer.

7. A composition of claim 6 wherein the ethylene copolymer is a copolymer of ethylene and an unsaturated carboxylic acid ester.

8. A composition of claim 1 wherein the ethylene copolymer is a copolymer of ethylene and a comonomer selected from the group consisting of acrylic acid, methacrylic acid, ethacrylic acid, methyl acrylate, ethyl acrylate, methyl methacrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, 2-hydroxyethyl methacrylate, vinyl acetic acid, vinyl acetate, vinyl propionate and mixtures thereof.

9. A composition of claim 1 wherein the ethylene copolymer is a copolymer of ethylene and a comonomer selected from the group consisting of maleic acid, itaconic acid, fumaric acid, itaconic anhydride, fumaric anhydride, maleic anhydride, citraconic anhydride, itaconic anhydride, tetrahydrophthalic anhydride, maleic acid monoesters, maleic acid diesters, fumaric acid monoesters and mixtures thereof.

10. A composition of claim 1 wherein the ethylene copolymer comprises copolymerized units of ethylene and ethylene/ethyl hydrogen maleate.

11. A process for preparing a cellulosic composite composition comprising the steps of
A) preparing a masterbatch comprising
1) from about 50 wt. % to about 95 wt. % of cellulosic material, based on the total weight of the masterbatch composition, and
2) from about 5 wt. % to about 10 wt. % of a coupling agent, based on the total weight of the masterbatch composition, wherein the coupling agent is selected from the group consisting of grafted polymers, ethylene copolymers, carboxylated polyacrylates and mixtures thereof; and
B) mixing said masterbatch with a material comprising polyvinyl chloride or polyvinyl chloride copolymer.
